(19) United States
(12) Patent Application Publication
(10) Pub. No.: US 2020/0340534 A1
(43) Pub. Date: Oct. 29, 2020

(54) FILTER FOR PROTECTING BEARING SYSTEM AND ASSOCIATED DRIVE WHEEL END

(71) Applicant: Consolidated Metco, Inc., Vancouver, WA (US)

(72) Inventor: Xin YU, Vancouver, WA (US)

(21) Appl. No.: 16/858,162

(22) Filed: Apr. 24, 2020

Related U.S. Application Data
(60) Provisional application No. 62/837,937, filed on Apr. 24, 2019.

(51) Int. Cl. F16C 33/78; F16C 19/38

(52) U.S. Cl. CPC F16C 33/78; F16C 19/38

(57) ABSTRACT

A drive wheel end includes a hub assembly, an axle, an axle shaft passing through an interior of the axle and rigidly coupled to the hub assembly outside the interior, a bearing system including (i) at least one bearing between the hub assembly and the axle and (ii) a bearing seal between the at least one bearing and an air side of the bearing system, and a filter spanning gap between the axle and at least one of the hub assembly and the axle shaft externally to the axle, to filter flow between the bearing system and the interior. The filter may include a frame and a flexible lip. The frame forms a central aperture and at least one opening radially outwards from the central aperture, and includes a size-discriminating material covering each opening. The flexible lip extends radially inwards from the frame.

### CROSS-REFERENCE TO RELATED APPLICATIONS

The present application claims the benefit of priority from U.S. Provisional Patent Application Ser. No. 62/837,937 filed on Apr. 24, 2019, which is incorporated herein by reference in its entirety.

### BACKGROUND

Wheel bearings generally require a bearing seal that seals between the bearing and the external environment, to prevent contaminants from entering the bearing and to at least reduce loss of oil from the bearing. A part of the bearing seal is affixed to the rotating part of the wheel assembly (the hub), and another part of the bearing seal is affixed to the stationary part of the wheel assembly (the axle). Many seals form a labyrinth between the rotating and stationary seal parts to create an arduous, labyrinth-shaped leakage path between bearing and the external environment. The most common type of seal has one or more elastomers that bridge across a labyrinth path between the spinning part of the seal and the non-spinning part of the seal to provide a physical barrier between the air side of the seal, associated with the external environment, and the oil side of the seal, i.e., the side of the seal where the bearing is located.

The bearing oil, that the seal is designed to help contain, helps ensure low friction at the elastomers. Typically, the seal includes a primary elastomer lip affixed to a part of the seal coupled to the hub and bridging across the labyrinth path to rub against the part of the seal coupled to the axle. When the primary elastomer lip and the part of the seal coupled to the axle begin rotating relative to each other, a thin layer of oil develops there. This oil layer helps ensure low-friction rotation. At first glance, it would appear that oil thus will escape to the air side through the small gap between the primary elastomer lip and the part of the seal coupled to the axle. However, the primary elastomer lip is shaped in an asymmetric manner that results in a net-pumping effect of oil from the air side toward the oil side, such that at least the majority of the oil that slips underneath the primary elastomer lip from the oil side to the air side is immediately pulled back to the oil side.

### SUMMARY

In an embodiment, a drive wheel end includes a hub assembly, an axle, an axle shaft passing through an interior of the axle and rigidly coupled to the hub assembly outside the interior, a bearing system including (i) at least one bearing between the hub assembly and the axle and (ii) a bearing seal between the at least one bearing and an air side of the bearing system, and a filter spanning gap between the axle and at least one of the hub assembly and the axle shaft externally to the axle, to filter flow between the bearing system and the interior.

In an embodiment, a filter for protecting a bearing system includes a frame and a flexible lip, each encircling a rotation axis. The frame forms (a) a central aperture intersected by the rotation axis and (b) at least one opening separate from and radially outwards from the central aperture. The frame includes a size-discriminating material covering the at least one opening. The flexible lip extends from the frame toward the rotation axis, and defines an inner diameter of the filter.

### BRIEF DESCRIPTION OF THE DRAWINGS

FIG. 1A illustrates one drive wheel end of a vehicle.

FIG. 1B illustrates certain properties of a bearing seal of the drive wheel end of FIG. 1A, according to an embodiment.

FIG. 2 illustrates a drive wheel end implementing a filter for protecting the bearing system of the drive wheel end, according to an embodiment.

FIG. 3 shows other examples of the arrangement of the filter in the drive wheel end of FIG. 2.

FIG. 4 illustrates a filter for protecting a bearing system of a drive wheel end, according to an embodiment.

FIG. 5 illustrates a filter with a plurality of openings covered by a size-discriminating material, according to an embodiment.

FIG. 6 illustrates a filter having a size-discriminating material that provide filtering in the full 360 degree range about the rotation axis, according to an embodiment.

FIG. 7 illustrates a drive wheel end that implements a filter such that a flexible lip of the filter is radially outwards from a flange of an axle-mounted portion of a bearing system, according to an embodiment.

FIG. 8 illustrates a drive wheel end that implements a filter such that a flexible lip of the filter is in direct contact with the axle, according to an embodiment.

FIG. 9 illustrates a drive wheel end in a scenario where the axle moves axially relative to the axle shaft and hub assembly, according to an embodiment.

FIG. 10 illustrates a filter having asymmetric filtering function, according to an embodiment.

FIG. 11 illustrates a drive wheel end having a filter clamped between a flange of the axle shaft and the hub assembly, according to an embodiment.

FIGS. 12A, 12B, and 12C illustrate a filter with a size-discriminating material held in place partly by an over-molded rubber gasket, according to an embodiment.

FIG. 13 illustrates a filter 1300 wherein a size-discriminating material is held in place in part by crimping, according to an embodiment.

FIGS. 14A, 14B, and 14C illustrate a filter that includes a washer for securing the size-discriminating material, according to an embodiment.

FIGS. 15A and 15B illustrates one example of the filter of FIGS. 14A-14C.

FIG. 16 illustrates a drive wheel end implementing the filter of FIGS. 15A and 15B.

### DETAILED DESCRIPTION OF THE EMBODIMENTS

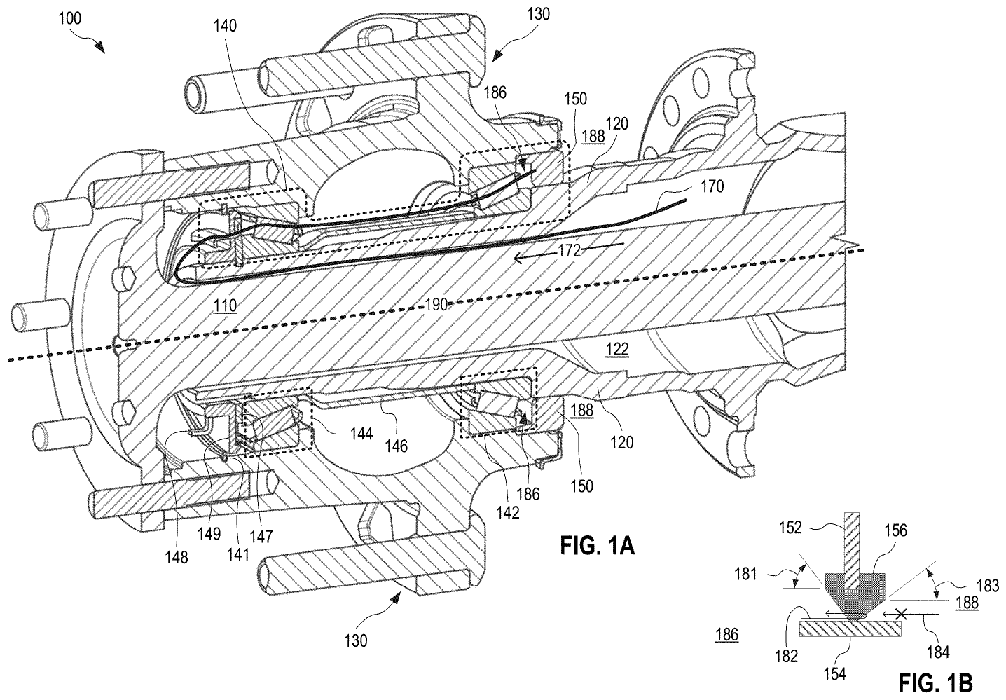

FIG. 1A illustrates one drive wheel end 100 of a vehicle, such as a tractor. FIG. 1A is an isometric full-section view showing one half of drive wheel end 100. The section used in FIG. 1A contains the rotation axis 190 of drive wheel end 100. FIG. 1B is a schematic view of certain features of a bearing seal 150 of drive wheel end 100, depicted in a cross-sectional view with the cross section being in a plane that contains rotation axis 190. FIGS. 1A and 1B are best viewed together in the following description.

Drive wheel end 100 includes an axle shaft 110, and axle 120, a hub assembly 130, and a bearing system 140. Axle shaft 110 passes through the interior 122 of axle 120, and is rigidly attached to hub assembly 130 outside axle 120. Hub assembly 130 is configured to accommodate a wheel (not shown in FIG. 1A). Axle 120 supports at least part of the load of the vehicle. To engage drive wheel end 100, an engine rotates axle shaft 110 via a drive line, which causes hub assembly 130 to rotate about axle 120.

Bearing system 140 reduces friction between hub assembly 130 and axle 120. For this purpose, bearing system 140 includes one or more bearings, for example an inboard bearing 142 and an outboard bearing 144, as depicted in FIG. 1. Bearing system 140 may further include (a) a spacer 146 limiting endplay of inboard bearing 142 and outboard bearing 144, (b) a lock ring 148, a lock washer 147, and a spindle nut 149 secured to axle 120, and (c) a snap ring 141 secured to hub assembly 130. Spacer 146, lock ring 148, lock washer 147, spindle nut 149, and snap ring 141 cooperate to keep inboard bearing 142 and outboard bearing 144 properly positioned and secured.

Bearing system 140 also includes bearing seal 150. Bearing seal 150 seals between (a) an “oil side” 186 of bearing seal 150, on which bearings 142 and 144 are located, and (b) an “air side” 188 of bearing seal 150 associated with the external environment of drive wheel end 100. Bearing seal 150 has two functions. One function is prevention or reduction of transport of contaminants from air side 188 to oil side 186, so as to protect bearings 142 and 144 from increased friction and/or damage induced by contamination. Another function is prevention or reduction of oil loss from bearing system 140 to air side 188. The presence of oil is critical to the function of both bearings 142 and 144 and bearing seal 150 itself.

Bearing seal 150 is of the contact-type and includes, for example as depicted in FIG. 1B, at least one lip 156 that bridges across helps between oil side 186 and air side 188. Lip 156 is, for example, made of an elastomer. Lip 156 is affixed to a seal case 152 that is coupled to hub assembly 130. Lip 156 bridges from seal case 152 to a sleeve 154 coupled to axle 120. When hub assembly 130 rotates about axle 120, lip 156 rotates about sleeve 154. At least ideally, a thin oil film (not visible in FIG. 1B) separates lip 156 and sleeve 154 from being in direct contact, thus reducing friction therebetween. In tractor wheel seal applications, the thickness of the oil film is typically in the range between 0.00004 and 0.0004 inches. Lip 156, together with the oil film, blocks or at least reduces transport 184 of liquids and/or other contaminants from air side 188 to oil side 186. On oil side 186, lip 156 is at an angle 181 to rotation axis 190. On air side 188, lip 156 is at an angle 183 to rotation axis 190. Angle 183 is smaller than angle 181, and this asymmetry creates a pumping effect 182 such that at least a majority of oil leaking underneath lip 156, from oil side 186 to air side 188, is pumped back to oil side 186.

During operation of drive wheel end 100, additional oil may enter bearing system 140 from interior 122 of axle 120, as indicated by oil path 170 and flow direction 172 in FIG. 1A. This oil supply often includes particulate matter that can damage bearing system 140. Such particulate matter may contain metal chips, rust, mill scales, welding slags, metal grind-off, lapping compound, etc. Bearing seal 150 is particularly susceptible to damage by larger particles. Larger particles may (a) increase the wear of lip 156, (b) damage the surface of lip 156 and adversely affect surface properties needed to maintain the oil film, (c) tear off parts of lip 156, and/or (d) get stuck under lip 156 and thus lift lip 156 away from sleeve 154 to open a substantial leak. Through lab testing, we have found that the life of certain embodiments of bearing seal 150, when operating drive wheel end 100 with realistic amounts of particulate debris in the oil supply, is reduced to only about 30% of the life achieved with clean oil.

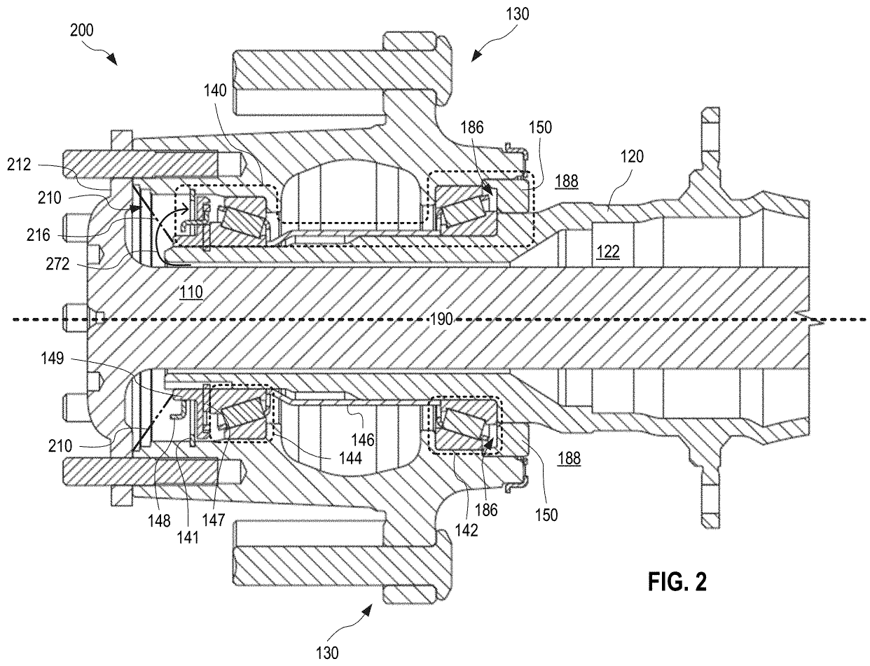

FIG. 2 illustrates one drive wheel end 200 implementing a filter 210 for protecting the bearing system. FIG. 2 is a section view of drive wheel end 200, with the section including rotation axis 190. Drive wheel end 200 is modification of drive wheel end 100 that further includes filter 210. Filter 210 interrupts an oil flow 272 from axle 120 toward bearing system 140. Oil flow 272 is a segment of the flow in flow direction 172 along oil path 170 of FIG. 1. As discussed above in reference to oil path 170 and flow direction 172, in the absence of filter 210, particulate contaminants in oil flow 272 may damage bearing system 140, in particular bearing seal 150. Filter 210 protects bearing system 140 from potentially damaging particulate matter in the oil flow 272 from axle 120 to bearing system 140.

Filter 210 encircles rotation axis 190 and spans the gap between axle 120 and at least one of hub assembly 130 and axle shaft 110 externally to axle 120. Since axle shaft 110 and hub assembly 130 rotate about axle 120, filter 210 is rigidly coupled to only one of (a) axle 120 and (b) hub assembly 130 and/or axle shaft 110. Filter 210 contacts the other one of (a) axle 120 and (b) hub assembly 130 and/or axle shaft 110, without being rigidly coupled therewith.

Filter 210 filters oil flow 272. More specifically, filter 210 blocks particles in oil flow 272 that are greater than a threshold size, while allowing flow of oil, other liquids than oil, particles smaller than the threshold size, and gas. For this purpose, filter 210 includes a size-discriminating material 216 that forms channels sized to allow passage only of particles smaller than the threshold size. Size-discriminating material 216 may be or include a mesh, a porous membrane, and/or a substrate with channels therethrough.

In our inspection of drive wheel ends, the quality of oil inside drive wheel ends, and the oil conditions under which bearing seals have been found to fail, we have found that the number of particles in the oil, inside the drive wheel ends, in the size range between 4 and 16 microns significantly exceeds the count recommended for reliable functioning of the bearing seals. The particle count is especially in excess of the recommended count for particles in the size range between 4 and 6 microns. However, particles in the size range of 14 microns and above also exceed the recommended count by a large margin, and larger particles typically cause more damage than smaller particles. Desirably, the threshold would be set to block all particles in the size range from about 4 microns and up. However, a size-discriminating material 216 configured to block very small particles is more prone to getting clogged than a size-discriminating material 216 configured to define a larger threshold size. Since oil changes are usually performed no more often than at every 300,000-500,000 miles, filter 210 will experience oil that is significantly degraded, e.g., thickened and may even tarred. This increases the risk of clogging of size-discriminating material 216. Thus, determination of the threshold size is a trade-off at least between good filtering and avoidance of clogging. In addition, size-discrimination materials having very fine channels tend to be more fragile and expensive. In one implementation, designed with this trade-off in mind, the threshold size is in the range between 10 and 100 microns, for example between 40 and 60 microns.

In one embodiment, filter 210 has the same filtering function on flow in the direction opposite oil flow 272 as on oil flow 272. In another embodiment, the function of filter 210 is asymmetric and filter 210 allows, at least under certain circumstances, particles larger than the threshold size to flow away from bearing system 140 (but not from axle 120 toward bearing system 140).

Without departing from the scope hereof, filter 210 may be implemented between an axle and a bearing system in drive wheel ends configured differently from drive wheel ends 100 and 200. For example, filter 210 may be implemented in a drive wheel end having a different type of bearing seal than bearing seal 150 and/or a different bearing configuration (e.g., a single bearing instead of two bearings). Filter 210 is expected to be useful in any type of wheel end having a bearing system and a flow of potentially contaminated oil from a shaft to the bearing system.

FIG. 2 shows filter 210 as spanning between spindle nut 149 and the junction between hub assembly 130 and a flange 212 of axle shaft 110. However, without departing from the scope hereof, filter 210 may be arranged differently within drive wheel end 200 as long as filter 210 spans the gap between axle 120 and at least one of hub assembly 130 and axle shaft 110 externally to axle 120, such that oil flow 272 cannot circumvent filter 210.

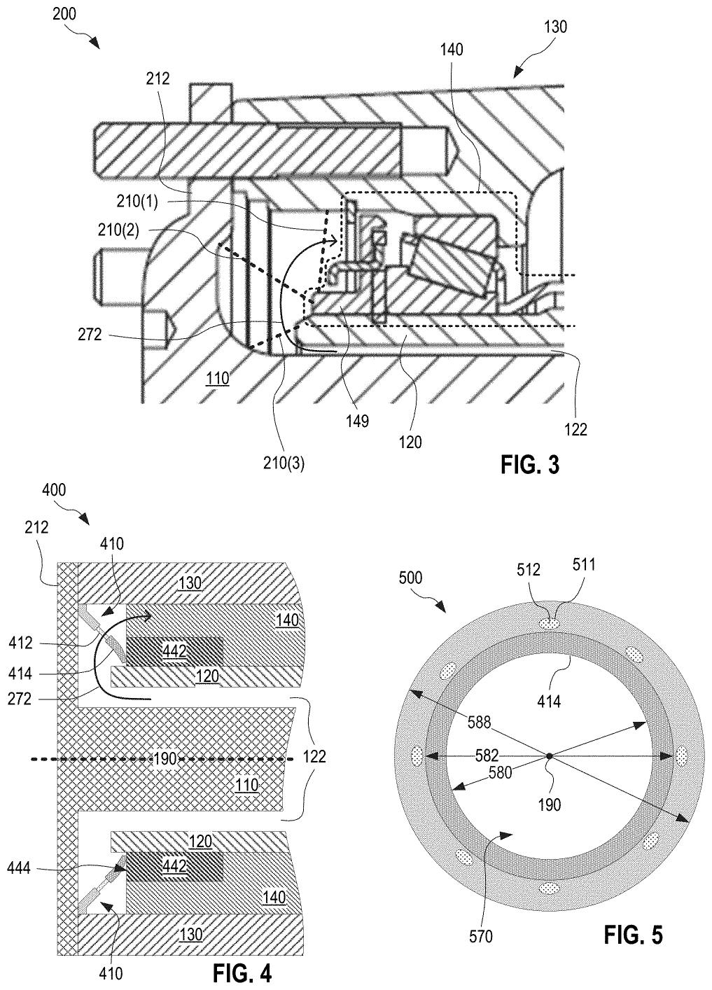

FIG. 3 shows other possible arrangements of filter 210 in drive wheel end 200. In one alternative embodiment, labeled 210(1), filter 210 is coupled between spindle nut 149 and hub assembly 130 away from flange 212. In another alternative embodiment, labeled 210(2), filter 210 is coupled between spindle nut 149 and flange 212 away from hub assembly 130. In yet another alternative embodiment, labeled 210(3), filter 210 is coupled between axle 120 and axle shaft 110, such that the edge of filter 210 connected to axle 120 has a larger diameter than the edge of filter 210 connected to axle shaft 110. It is understood the numerous other viable options exist. For example, filter 210 may be coupled between (a) axle 120 and (b) flange 212 and/or hub assembly 130.

It is understood that filter 210 may be provided as a standalone part configured for implementation in a third-party drive wheel end.

FIG. 4 illustrates one filter 410 for protecting bearing system 140 of a drive wheel end 400. Filter 410 is an embodiment of filter 210, and drive wheel end 400 is an embodiment of drive wheel end 200. FIG. 4 shows a cross section of drive wheel end 400, with the cross section containing rotation axis 190.

Filter 410 includes a size-discriminating material 412 and a flexible lip 414. Size-discriminating material 412 is an embodiment of size-discriminating material 216. An outer perimeter of filter 410 is rigidly coupled to the junction of flange 212 and hub assembly 130, whereas an inner perimeter of filter 410, defined by flexible lip 414, contacts but is not affixed to a surface 444 of an axle-mounted portion 442 of bearing system 140. Axle-mounted portion 442 is rigidly coupled to axle 120. Axle-mounted portion 442 may, but need not, include a spindle nut such as spindle nut 149. Surface 444 may be orthogonal to rotation axis 190, as depicted in FIG. 4, or at an oblique angle to rotation axis 190. This oblique angle may be greater than 45 degrees. Filter 410 is mounted such that axle-mounted portion 442 applies some pressure on flexible lip 414, to ensure that flexible lip 414 is sealed against axle-mounted portion 442 at least in the absence of other forces not generated by filter 410 or axle-mounted portion 442. Flexible lip 414 allows for sealing of filter 410 to surface 444, even when filter 410 rotates relative to axle 120. As a result oil flow 272 must pass through size-discriminating material 412 in order to reach bearing system 140.

Filter 410 may be clamped between flange 212 and hub assembly 130. For example, filter 410 may be placed between flange 212 and hub assembly 130 such that the act of bolting flange 212 to hub assembly 130 secures filter 410. In an alternative embodiment, filter 410 may be screwed or otherwise affixed to flange 212 and/or hub assembly 130.

FIG. 5 illustrates a filter 500 for protecting a bearing system, such as bearing system 140. FIG. 5 shows filter 500 as viewed from a direction that is along rotation axis 190. Filter 500 is an embodiment of filter 410 that forms a plurality of openings 511, each covered by a size-discriminating material 512. Size-discriminating material 512 is an embodiment of size-discriminating material 412. In one implementation, size-discriminating material 512 is a mesh or a porous membrane. Openings 511 are distributed about rotation axis 190, radially outward from flexible lip 414. It is understood that filter 500 may form fewer or more openings 511 than depicted in FIG. 5.

Flexible lip 414 defines an inner diameter 580 of filter 500. Inner diameter 580 defines a central aperture 570 of filter 500. Flexible lip 414 has an outer diameter 582, beyond which filter 500 is substantially rigid, apart, possibly, from (a) size-discriminating material 412 which may lack some rigidity and (b) a gasket, not shown in FIG. 5, configured to help secure filter 500 in a drive wheel end. Filter 500 has an outer diameter 588.

In one example, outer diameter 588 is in the range between 4 and 10 inches, inner diameter 580 is between 40% and 70% of outer diameter 588, and diameter 582 is between 60% and 90% of outer diameter 588.

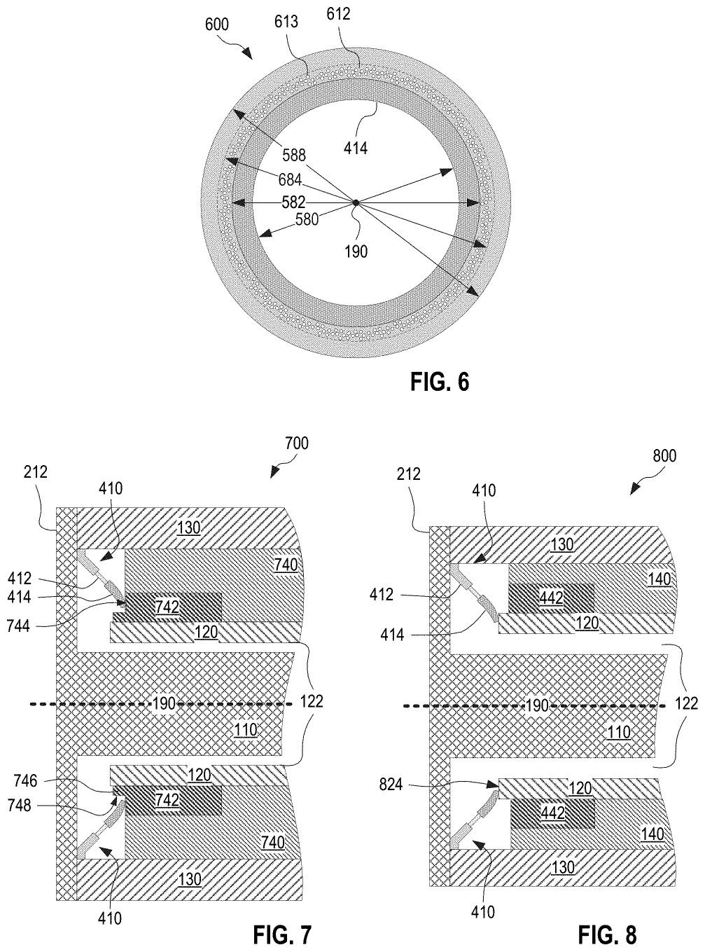

FIG. 6 illustrates another filter 600, for protecting a bearing system such as bearing system 140, which has a size-discriminating material 612 that encircles rotation axis 190 to provide filtering in the full 360 degree range about the rotation axis. FIG. 6 shows filter 600 as viewed from a direction that is along rotation axis 190. Filter 600 is an embodiment of filter 410. Size-discriminating material 612 forms a plurality of channels 613. Each channel 613 is sized to allow passage only of particles smaller than the threshold size. Channels 613 may be relatively uniformly distributed within a region that (a) encircles rotation axis 190 and (b) spans from diameter 582 to a larger diameter 684. Diameter 582 may be less than outer diameter 588, as depicted in FIG. 6, or the same as outer diameter 588. Size-discriminating material 612 is, for example, a substrate with channels 613 machined or etched therethrough.

FIG. 7 illustrates one drive wheel end 700 that implements filter 410 such that flexible lip 414 is radially outwards from a flange 746 of an axle-mounted portion 742 of a bearing system 740. Drive wheel end 700 is an embodiment of drive wheel end 200. Bearing system 740 is an embodiment of bearing system 140. In drive wheel end 700, flexible lip 414 presses against a surface 744 of axle-mounted portion 742. Flexible lip 414 is radially outwards from a surface 748 of flange 746, but the position of at least a portion of flexible lip 414 overlaps with surface 748 in the dimension parallel to rotation axis 190. In one embodiment, surface 744 is orthogonal to rotation axis 190, and surface 748 is parallel to rotation axis. In another embodiment, one or both of surfaces 744 and 748 is at an oblique angle to rotation axis 190. For example, the angle between surface 744 and rotation axis 190 may be more than 45 degrees and less than 90 degrees. In one implementation, surfaces 744 and 748 are surfaces of spindle nut 149.

In drive wheel end 700, filter 410 may be clamped between flange 212 and hub assembly 130. For example, filter 410 may be placed between flange 212 and hub assembly 130 such that the act of bolting flange 212 to hub assembly 130 secures filter 410. In an alternative embodiment, filter 410 may be screwed or otherwise affixed to flange 212 and/or hub assembly 130.

FIG. 8 illustrates one drive wheel end 800 that implements filter 410 such that flexible lip 414 is in direct contact with axle 120. In drive wheel end 800, flexible lip 414 does not contact bearing system 140. Instead, flexible lip 414 presses against a surface 824 of axle 120. Surface 824 may be orthogonal to rotation axis 190 or at an oblique angle to rotation axis 190. The oblique angle may be greater than 45 degrees and less than 90 degrees.

In drive wheel end 800, filter 410 may be clamped between flange 212 and hub assembly 130. For example, filter 410 may be placed between flange 212 and hub assembly 130 such that the act of bolting flange 212 to hub assembly 130 secures filter 410. In an alternative embodiment, filter 410 may be screwed or otherwise affixed to flange 212 and/or hub assembly 130.

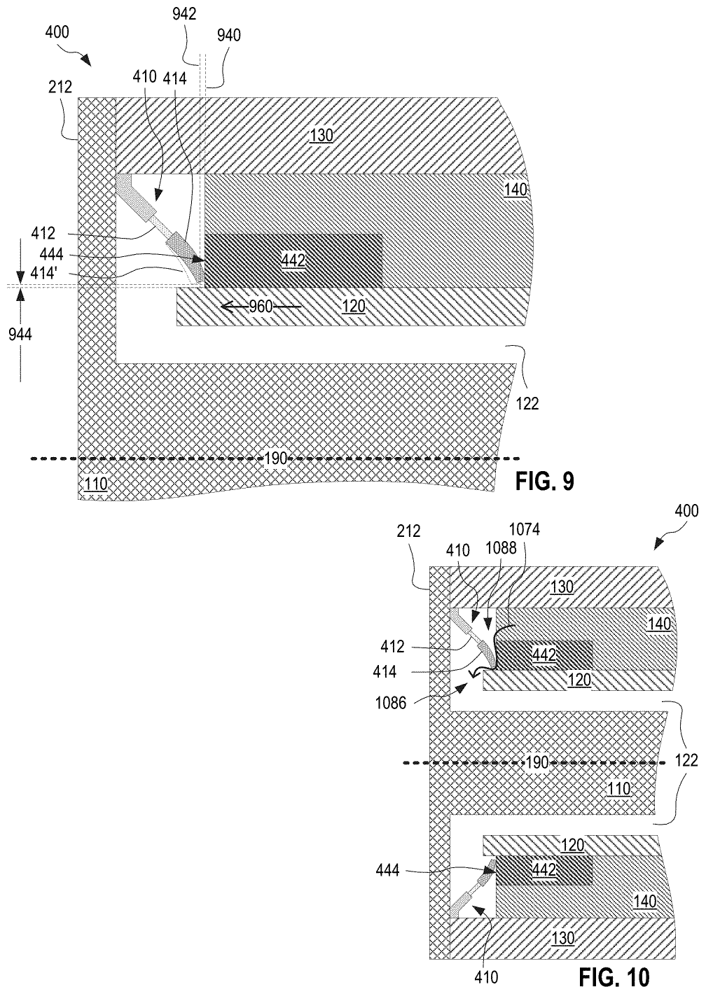

FIG. 9 illustrates drive wheel end 400 in one scenario where axle 120 moves axially relative to axle shaft 110 and hub assembly 130. FIG. 9 shows a cross section of drive wheel end 400 taking in a plane that contains rotation axis 190. Axial play in drive wheel end 400 may result in this scenario. When axle 120 moves in a direction 960 relative to axle shaft 110, surface 444, against which flexible lip 414 presses, is translated from its nominal axial position 940 to a shifted axial position 942 closer to flange 212. As a result, flexible lip 414 is deflected axially in direction 960 and also radially inwards toward axle 120, as indicated by dashed outline 414′. In certain embodiments, drive wheel end 400 is configured to ensure that a non-zero radial clearance 944 exists between flexible lip 414 and axle 120 for the greatest possible axial movement of axle 120 in direction 960 relative to axle shaft 110. A similar scenario applies to drive wheel end 700, which may be designed to ensure radial clearance between flexible lip 414 and surface 748 within the possible range of axial play in drive wheel end 700.

Axial play in drive wheel end 400 may also cause axle 120 to move relative to axle shaft 110 and hub assembly 130 in the direction opposite direction 960. Flexible lip 414 may be configured to remain in contact with surface 444 in the presence of such movement, at least within the possible range of axial play in drive wheel end 400. A similar scenario applies to each of drive wheel ends 700 and 800, wherein flexible lip 414 may be configured to remain in contact with surfaces 744 and 824, respectively, possible range of axial play in drive wheel ends 700 and 800.

FIG. 10 illustrates an asymmetric filtering function of filter 410, as implemented in a drive wheel end 400. FIG. 10 shows a cross section of drive wheel end 400 taken in a plane that includes rotation axis 190.

When flexible lip 414 rotates relative to surface 444, a thin oil film develops between flexible lip 414 and surface 444. Flexible lip 414 may be configured to function as a pump, in a manner similar to lip 156 discussed above in reference to FIG. 1B, such that flexible lip 414 continuously pumps oil from a side 1088 of filter 410 toward a side 1086 of filter 410 along a flow pathway 1074. Flow pathway 1074 is an unfiltered unidirectional pathway that, when open, allows transport, e.g., oil, other liquids, and particulate matter out of bearing system 140 to side 1086 of filter 410. Flow pathway 1074 may thus help flush contaminants out of bearing system 140.

Size-discriminating material 412 allows for balancing of any pressure difference between sides 1086 and 1088 of filter 410. Pressure changes by more than, e.g., 3 pounds per square-inch (PSI), can significantly affect the performance of bearing seal 150. Positive pressure in hub assembly 130 can increase the force on a primary elastomer lip of bearing seal 150 and thereby increase the wear on this lip as well as its temperature. Negative pressure in hub assembly 130 may allow moisture entering hub assembly 130 and contaminate the lubricant. For a truck configured with drive wheel end 400, the temperature increase experienced from cold start to normal operating temperature can, in the absence of a venting mechanism, lead to an increase in pressure in hub assembly 130 by about 3 PSI. Elevation change can cause similar pressure changes, in the absence of a venting mechanism. To prevent such pressures from building, most drive wheel ends are configured with a vent, typically in the axle housing. Size-discriminating material 412 provides a path way between hub assembly 130 and such a vent. Size-discriminating material 412 thus allows for balancing of pressure to avoid these undesirable pressure changes. Size-discriminating material 412 also allows for replenishing bearing system 140 with lubricant to compensate for lubricant loss by pumping of flexible lip 414. Furthermore, the pressure-balancing function of size-discriminating material 412 prevents “burping” by flexible lip 414, which otherwise could result if the pressure on side 1088 significantly exceeded the pressure on side 1086. Such burping is undesirable since it may deplete lubricant from bearing system 140.

FIG. 11 illustrates one drive wheel end 1100 having a filter 1110 clamped between flange 212 and a hub assembly 1130. Drive wheel end 1100 is an embodiment of drive wheel end 400. Hub assembly 1130 is an embodiment of hub assembly with a recess 1132 configured to accommodate filter an outer edge 1116 of filter 1110. Filter 1110 is an embodiment of filter 410 configured with an outer edge 1116 suitable for clamping between flange 212 and hub assembly 1130 in recess 1132.

In an alternative embodiment, recess 1132 is formed in flange 212 instead of hub assembly 1130, or recess 1132 is form partly in flange 212 and partly in hub assembly 1130.

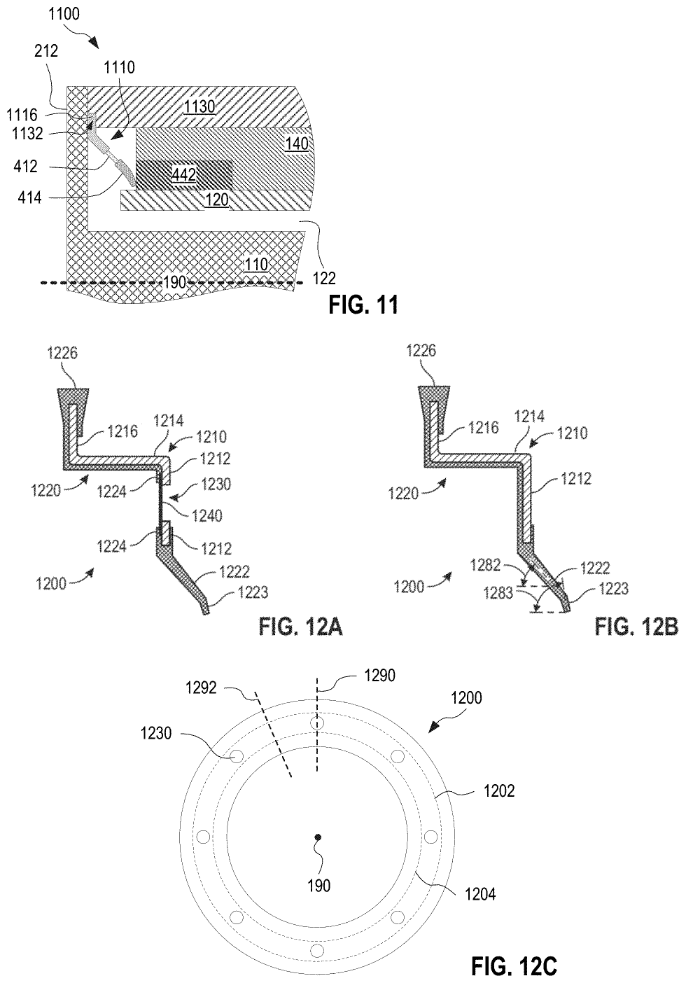

FIGS. 12A-C illustrate one filter 1200 with a size-discriminating material 1240 held in place partly by an over-molded rubber gasket 1220. Filter 1200 is an embodiment of filter 410. FIG. 12C is a view of filter 1200 taken along rotation axis 190. FIGS. 12A and 12B are cross sections of filter 1200 taken along lines 1290 and 1292, respectively, of FIG. 12C. The cross sections depicted in FIGS. 12A and 12B are taken in planes that contain rotation axis 190. FIGS. 12A-C are best viewed together in the following description.

Filter 1200 includes a frame 1210, size-discriminating material 1240 (an embodiment of size-discriminating material 412), and rubber gasket 1220. Frame 1210 includes an inner radial leg 1212, and outer radial leg 1216, and an axial leg 1214 connecting radial legs 1212 and 1216. Herein, a “radial leg” refers to a leg that is predominantly orthogonal to rotation axis 190, and an “axial leg” refers to a leg that is predominantly parallel with rotation axis 190. Inner radial leg 1212 extends between diameters 1202 and 1204 in FIG. 12C. Each of legs 1212, 1214, and 1216 encircle rotation axis 190. Rubber gasket 1220 also encircles rotation axis 190.

Leg 1212 forms a plurality of openings 1230. The FIG. 12A cross section coincides with an opening 1230, whereas the FIG. 12B cross section is away from openings 1230. Each opening 1230 is covered by size-discriminating material 1240. To make filter 1200, size-discriminating material 1240 is positioned on one side of leg 1212 (typically the side of leg 1212 that receives flow from axle 120) to cover openings 1230, whereafter rubber gasket 1220 is over-molded onto frame 1210. Portions 1224 of rubber gasket 1220 surrounding each opening 1230 extend over size-discriminating material 1240 and help secure size-discriminating material 1240 to frame 1210.

In one embodiment, rubber gasket 1220 covers all of leg 1212 apart from openings 1230. In this embodiment, FIG. 12B is representative of the cross section of filter 1200 for all possible positions of line 1292, orthogonal to rotation axis 190, away from openings 1230. In another embodiment, rubber gasket 1220 spans the radial extent of leg 1212 only within a smaller azimuthal range between each pair of adjacent openings 1230.

Each opening 1230 may be circular and have a diameter in the range between 0.2 and 0.6 inches. In one embodiment, filter 1200 forms between 4 and 20 openings 1230.

In the embodiment depicted in FIGS. 12A and 12B, radial legs 1212 and 1216 are orthogonal to rotation axis 190, and axial leg 1214 is parallel with rotation axis 190. In an alternative embodiment, one or both of radial legs 1212 and 1216 is at an oblique angle to rotation axis 190 that is more than 45 degrees and/or axial leg 1214 is at an oblique angle to rotation axis 190 that is less than 45 degrees. Certain advantages may be associated with radial legs 1212 and 1216 being orthogonal to rotation axis 190. When radial legs 1212 and 1216 are orthogonal to rotation axis 190, each of radial legs 1212 and 1216 is a planar annular disk. Positioning of size-discriminating material 1240 on a planar surface may be easier than positioning of size-discriminating material 1240 on a non-planar (e.g., conical) surface, especially in embodiments where size-discriminating material 1240 is one continuous piece that encircles rotation axis 190. Planarity of radial leg 1216 may simplify mounting of filter 1200 in a drive wheel end. For example, the configuration of filter 1200 depicted in FIGS. 12A-C is suitable for mounting in drive wheel 1100 with radial leg 1216 clamped between flange 212 and hub assembly 1130.

Rubber gasket 1220 forms a flexible lip 1222 (an example of flexible lip 414) that extends radially inwards from an inner-diameter edge of leg 1212. Flexible lip 1222 is generally at an oblique angle to rotation axis 190. A main segment of flexible lip 1222, proximal leg 1212, may be at an angle 1282 to rotation axis. However, flexible lip 1222 may terminate in a distal end 1223 characterized by a steeper angle 1283 to rotation axis. Angle 1283 of distal end 1223 may help provide a good seal between flexible lip 1222 and the part of a drive wheel end against which flexible lip 1222 is configured to press. Angle 1283 is closer than angle 1282 to ninety degrees. In one embodiment, angle 1282 is in the range between 30 and 50 degrees, and angle 1283 is in the range between 55 and 75 degrees, when no pressure is applied to flexible lip 1222.

Frame 1210 may be made of metal or plastic. Frame 1210 may be rigid, or at least less flexible than flexible lip 1222.

Rubber gasket 1220 may also extend along axial leg 1214 and outer radial leg 1216, and form an outer gasket portion 1226 around the outer-diameter edge of radial leg 1216 to help seal filter 1200 to flange 212 and/or hub assembly 130/1130, so as to prevent any leaks along joint between filter 1200 and the structure to which filter 1200 is mounted in a drive wheel end. Without departing from the scope hereof, the configuration of rubber gasket 1220 at legs 1214 and/or 1216 may be different from what is depicted in FIGS. 12A and 12B. The embodiment depicted in FIGS. 12A and 12B is particularly well suited for implementation in drive wheel end 1100, at least by virtue of outer gasket portion 1226. However, filter 1200 may be mounted in the drive wheel end in other ways. For example, radial leg 1216 may be screwed onto flange 212, in which case rubber gasket 1220 may advantageously cover a portion of radial leg 1216 that encircles rotation axis 190 but outer gasket portion 1226 may be omitted. In another example, radial leg 1216 is omitted entirely, and axial leg 1214 is screwed onto hub assembly 130. In this latter example, rubber gasket 1220 may extend along the radially outwards-facing surface of axial leg 1214 to seal axial leg 1214 to hub assembly 130. Also without departing from the scope hereof, embodiments of filter 1200 that include outer radial leg 1216 may form openings 1230 in axial leg 1214 instead of in inner radial leg 1212.

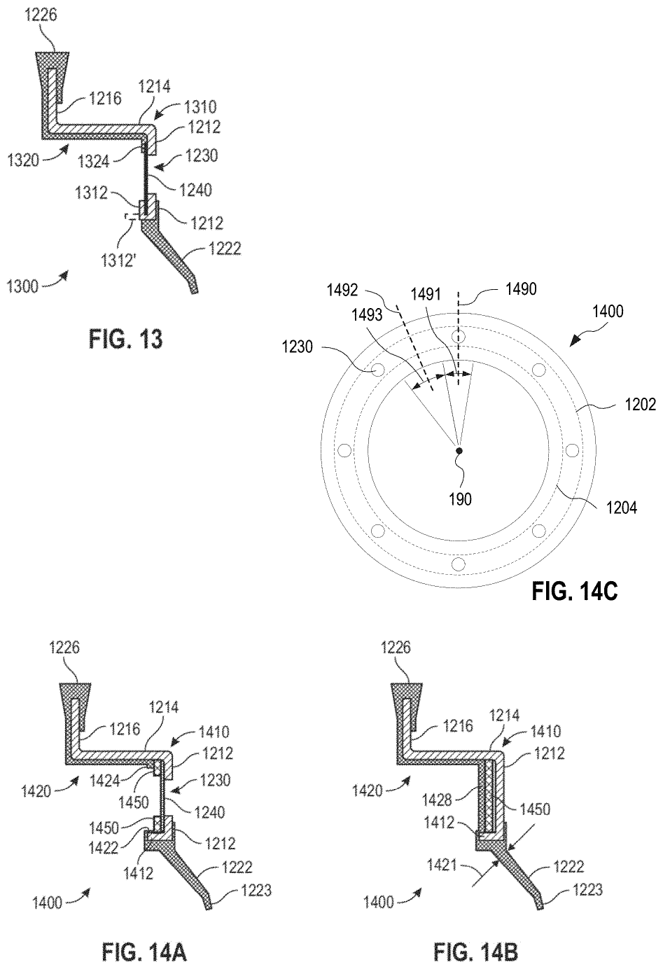

FIG. 13 illustrates a cross section of one filter 1300 wherein size-discriminating material 1240 is held in place in part by crimping. The cross section depicted in FIG. 13 is a view similar to that used in FIG. 12A. Filter 1300 is an embodiment of filter 410. Filter 1300 is similar to filter 1200 except for how size-discriminating material 1240 is secured. Filter 1300 replaces frame 1210 and rubber gasket 1220 with a frame 1310 and a rubber gasket 1320, respectively. Frame 1310 is similar to frame 1210 except for further including an extension 1312 of inner radial leg 1212 which is crimped around an inner diameter edge of size-discriminating material 1240 to help secure size-discriminating material 1240 to radial leg 1212. Rubber gasket 1320 is similar to rubber gasket 1220 except for not being over-molded onto any portion of size-discriminating material 1240. Rubber gasket 1320 forms a radially inward-facing rib 1324. To make filter 1300, rubber gasket 1320 is over-molded onto frame 1310, whereafter size-discriminating material 1240 is positioned on radial leg 1212 with an outer-diameter edge of size-discriminating material 1240 tucked under rib 1324. Up until this point, extension 1312 is in an initial configuration 1312′. Next, extension 1312 is bent from its initial configuration 1312′ onto an inner-diameter edge of size-discriminating material 1240 to secure size-discriminating material 1240.

The configuration of filter 1300 may be a better solution for securing size-discriminating material 1240, especially when size-discriminating material 1240 is a mesh. The over-molding technique used to secure size-discriminating material 1240 in filter 1200 may present challenges when size-discriminating material 1240 is a mesh. Over-molding of rubber gasket 1220 to frame 1210 over size-discriminating material 1240 in filter 1200 requires a tight seal between a mold and frame 1210/size-discriminating material 1240 around each opening 1230, so as to avoid rubber spreading to size-discriminating material 1240 inside opening 1230. Such a tight seal requires sandwiching size-discriminating material 1240 between frame 1210 and the mold with a very high pressure. This very high pressure may crush size-discriminating material 1240 when size-discriminating material 1240 is a mesh. However, even in the configuration of filter 1300, it may be difficult to secure a mesh-type embodiment of size-discriminating material 1240. Especially when the mesh lacks rigidity (e.g., is flimsy), the crimping method may fail to secure the mesh.

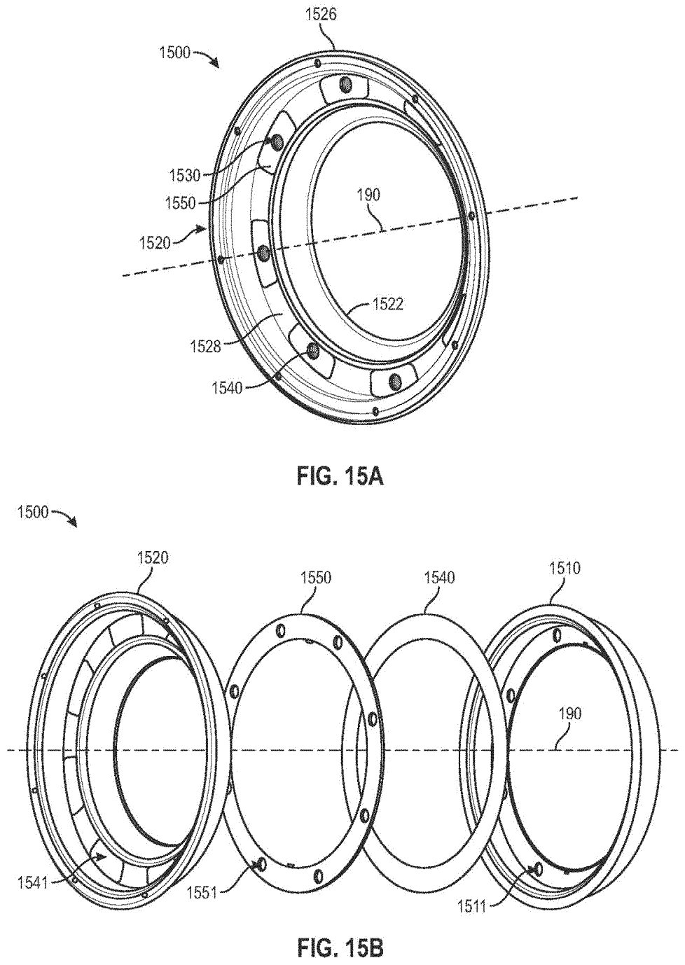

FIGS. 14A-14C illustrate one filter 1400 that includes a washer 1450 for securing size-discriminating material 1240. The configuration of filter 1400 overcomes the issues discussed above for mesh-type embodiments of size-discriminating material 1240 in filters 1200 and 1300. FIG. 14C is a view of filter 1400 taken along rotation axis 190. FIGS. 14A and 14B are cross sections of filter 1400 taken along lines 1490 and 1492, respectively, of FIG. 14C. The cross sections depicted in FIGS. 14A and 14B are taken in planes that contain rotation axis 190. FIGS. 14A-14C are best viewed together in the following description.

Filter 1400 is an embodiment of filter 410. Filter 1400 is similar to filter 1200 except for how size-discriminating material 1240 is secured. Filter 1400 replaces frame 1210 and rubber gasket 1220 with a frame 1410 and a rubber gasket 1420, respectively. Filter 1400 further includes a washer 1450. Washer 1450 may be made of metal or plastic. Frame 1410 is similar to frame 1210 except for further including an axial leg 1412 connected to an radially innermost extreme of inner radial leg 1212. Size-discriminating material 1240 and washer 1450 are placed on inner radial leg 1212 between axial legs 1214 and 1412, with size-discriminating material 1240 being placed between inner radial leg 1212 and washer 1450. Rubber gasket 1420 is similar to rubber gasket 1220 except for not being over-molded onto any portion of size-discriminating material 1240, but instead being over-molded onto washer 1450 and around axial leg 1412. Openings 1230 pass through each of frame 1410 and washer 1450 and are covered by size-discriminating material 1240. Each of inner radial leg 1212 and washer 1450 may be planar.

To make filter 1400, size-discriminating material 1240 is positioned on inner radial leg 1212, and washer 1450 is positioned on top of size-discriminating material 1240 on inner radial leg 1212. Next, rubber gasket 1420 is over-molded onto frame 1410 and washer 1450 such that, at least in a plurality of first azimuthal ranges 1493 away from openings 1230, a portion 1428 of rubber gasket 1420 extends across inner radial leg 1212 from axial leg 1412 to axial leg 1214 (as depicted in FIG. 14B). Herein, an “azimuthal range” refers to a range of angle in the azimuthal dimension relative to rotation axis 190. Washer 1450 provides a solid load-bearing surface a mold used to form rubber gasket 1420, thereby eliminating any issues that may otherwise result when pressing the mold directly against mesh-type embodiments of size-discriminating material 1240. At a plurality of remaining second azimuthal ranges 1491 at openings 1230, smaller portions 1422 and 1424 of rubber gasket 1420 extend along washer 1450 toward openings 1230 from axial legs 1214 and 1412, respectively (as depicted in FIG. 14A). Portions 1422 and 1424 prevent leakage paths from forming around the outer and inner diameters of washer 1450.

The relative proportions of the full 360 degree azimuthal range about rotation axis 190 occupied by the azimuthal ranges 1491 and 1493 may vary between different embodiments of filter 1400. Generally, it is expected that washer 1450, and thus size-discriminating material 1240, are better secured when a larger proportion of the full 360 degree azimuthal range is occupied by azimuthal ranges 1493. However, a good mold interface, for over-molding rubber gasket 1420, may be more easily achieved with ample space available in azimuthal ranges 1491. In certain embodiments, each azimuthal range 1491 has a width of between 20 and 30 degrees. In one such embodiment, filter 1400 forms eight openings 1230.

Finite-element analysis may be used to optimize the shape and thickness of flexible lip 1222 in filter 1400, for example so as to behave according to the scenarios discussed above in reference to FIGS. 9 and 10. Generally, the ideal value of the maximum thickness 1421 of flexible lip 1222 is an increasing function of the distance spanned by flexible lip 1222 between frame 1410 and distal end 1223. In one embodiment of filter 1400, where the distance spanned by flexible lip 1222 between frame 1410 and distal end 1223 is approximately 8 millimeters, the thickness of flexible lip 1222 tapers in the direction away from frame 1410, and the maximum thickness 1421 of flexible lip 1222 is no greater than 2 millimeters, for example between 1.0 and 1.2 millimeters. Finite-element analysis has shown that in this embodiment of filter 1400, flexible lip 1222 behaves according to the scenarios discussed above in reference to FIGS. 9 and 10. For a shorter distance spanned by flexible lip 1222, maximum thickness 1421 may be smaller, e.g., between 0.4 and 1.0 millimeters.

FIGS. 15A and 15B illustrate one filter 1500 that is an example of filter 1400. FIG. 15A shows filter 1500 in perspective view, and FIG. 15B is an exploded view of filter 1500. Filter 1500 includes a frame 1510, a mesh 1540, a washer 1550, and a rubber gasket 1520, which are embodiments of frame 1410, size-discriminating filter 1240, washer 1450, and rubber gasket 1420, respectively. Frame 1510 forms openings 1511, and washer 1550 forms openings 1551 that coincide with openings 1511. Openings 1511 and 1551 together define openings 1530. Mesh 1540 is sandwiched between frame 1510 and washer 1550 to cover openings 1530. Rubber gasket 1520 also forms openings 1541. Openings 1541 are bigger than openings 1551 to make room for pressing a mold to washer 1550 when forming rubber gasket 1520 with portions 1528 molded onto washer 1550. Rubber gasket 1520 includes a flexible lip 1522. Rubber gasket 1520 also includes an outer gasket portion 1526 configured to aid in securing and sealing filter 1500 in a drive wheel end.

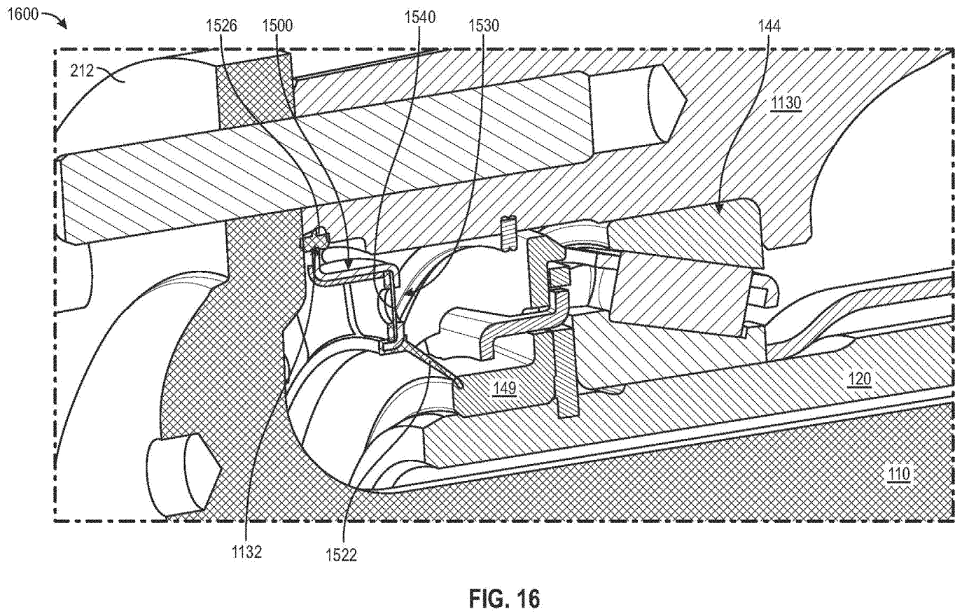

FIG. 16 illustrates one drive wheel end 1600 implementing filter 1500. Drive wheel end 1600 is an embodiment of drive wheel end 1100. In drive wheel end 1600, filter 1500 is clamped in place between flange 212 and hub assembly 1130, with the outer perimeter of filter 1500 being positioned in recess 1132 of hub assembly 1130. Outer gasket portion 1526 helps seal filter 1500 to flange 212 and hub assembly 1130, to prevent leakage around the outer perimeter of filter 1500. Flexible lip 1522 presses against spindle nut 149.

Changes may be made in the above systems and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present systems and methods, which, as a matter of language, might be said to fall therebetween.

What is claimed is:

1. A drive wheel end, comprising:
a hub assembly;
an axle;
an axle shaft passing through an interior of the axle and rigidly coupled to the hub assembly outside the interior;
a bearing system including:
at least one bearing between the hub assembly and the axle, and
a bearing seal between the at least one bearing and an air side of the bearing system; and
a filter spanning gap between the axle and at least one of the hub assembly and the axle shaft externally to the axle, to filter flow between the bearing system and the interior.

2. The drive wheel end of claim 1, the filter extending radially outward from the axle.

3. The drive wheel end of claim 1, the filter including a size-discriminating material configured to allow passage of air and oil but prevent passage of particles and objects greater than a threshold size.

4. The drive wheel end of claim 3, the size-discriminating member including a mesh.

5. The drive wheel end of claim 3, the filter further including a flexible lip configured to allow rotation of the hub assembly and axle shaft relative to the axle while the filter spans the gap.

6. The drive wheel end of claim 3, the filter including a ring rigidly coupled to at least one of the hub assembly and the axle shaft, the ring having at least one opening covered by the size-discriminating material.

7. The drive wheel end of claim 6, the filter further including a flexible lip attached to the ring and pressing against the axle or a component rigidly coupled to the axle.

8. The drive wheel end of claim 7, the axle shaft including a flange bolted onto the hub assembly, a radially outermost edge of the ring being clamped between the flange and the hub assembly, the flexible lib extending radially inwards from the ring to contact the axle or the component.

9. The drive wheel end of claim 8, the flexible lip pressing against a surface of the axle shaft, or the component, that faces in a first axial direction toward the flange and away from the bearing system.

10. The drive wheel end of claim 9, the flexible lip being configured to allow flow of lubricant between the hub assembly and the axle only in direction from the hub assembly toward the axle shaft.

11. The drive wheel end of claim 9, the bearing system including a spindle nut affixed on a radially outward-facing surface of the axle for axially securing the at least one bearing, the surface being a surface of the spindle nut.

12. The drive wheel end of claim 1, the at least one bearing including an inboard bearing and an outboard bearing, the filter being closer than the outboard bearing to a distal extreme of the drive wheel end, the bearing seal being farther than the inboard bearing from the distal extreme.

13. A filter for protecting a bearing system, comprising:
a frame encircling a rotation axis, the frame forming (a) a central aperture intersected by the rotation axis and (b) at least one opening separate from and radially outwards from the central aperture, the frame including a size-discriminating material covering the at least one opening; and
a flexible lip encircling the rotation axis, extending from the frame toward the rotation axis, and defining an inner diameter of the filter.

14. The filter of claim 13, the size-discriminating material including a mesh.

15. The filter of claim 13, the at least one opening including a plurality of openings disposed at different respective azimuthal positions relative to the rotation axis.

16. The filter of claim 13, the flexible lip being molded onto the frame.

17. The filter of claim 16, for each of the at least one first opening, the size-discriminating material being disposed on an edge of the frame surrounding the first opening.

18. The filter of claim 17, further including a washer encircling the rotation axis and disposed on the size-discriminating material to hold the size-discriminating material between the frame and the washer, each of the at least one opening passing through the washer.

19. The filter of claim 18, further including a rubber gasket over-molded onto the frame, the rubber gasket (a) spanning over the washer, away from the at least one opening, to help secure the washer and the size-discriminating material on the frame and (b) forming the flexible lip.

20. The filter of claim 19, the rubber gasket spanning across the washer, from an inner diameter of the washer to an outer diameter of the washer, in one or more azimuthal ranges away from the at least one opening.

21. The filter of claim 19, the rubber gasket spanning around a radially outermost edge of the frame.

22. The filter of claim 16, the frame including:
an inner radial leg, each of the at least one opening passing through the inner radial leg, the size-discriminating material being disposed on the inner radial leg;
an outer radial leg defining an outer diameter of the rigid frame; and
a first axial leg between the inner radial leg and the outer radial leg.

23. The filter of claim 22, further including a washer encircling the rotation axis and seated on the inner radial leg with the size-discriminating material therebetween, to hold the size-discriminating material between the frame and the washer, each of the at least one opening passing through the washer.

24. The filter of claim 23, the frame further including a second axial leg extending predominantly parallel to the rotation axis from an innermost extreme of the inner radial leg, the washer being disposed on the inner radial leg between the first axial leg and the second axial leg.

25. The filter of claim 13, the flexible lib extending from the frame toward the rotation axis at an oblique angle to the rotation axis.

26. The filter of claim 25, the flexible lib including:
a proximal portion closer to the frame and oriented at a first angle relative to the rotation axis; and
a distal portion farther from the frame and oriented at a second angle relative to the rotation axis, the second angle being closer than the first angle to ninety degrees.

27. The filter of claim 26, the flexible lip being made of rubber, the proximal portion being no thicker than two millimeters.

28. A method for manufacturing a filter for protecting a bearing system, comprising:
covering each of at least one first opening in a ring-shaped frame with a size-discriminating material;
disposing a washer on the ring-shaped frame, such that the size-discriminating material is between the ring-shaped frame and the washer, the washer forming, for each of the at least one first opening, a second opening coinciding with the first opening; and
over-molding a rubber gasket onto the ring-shaped frame to (a) secure the washer to the ring-shaped frame and (b) form a flexible lib extending radially inwards from the ring-shaped frame.
